(19) United States
(12) Patent Application Publication
(10) Pub. No.: US 2026/0016908 A1
(43) Pub. Date: Jan. 15, 2026

(54) INFORMATION PROCESSING DEVICE AND INFORMATION PROCESSING METHOD

(71) Applicant: SONY GROUP CORPORATION, Tokyo (JP)

(72) Inventor: Ryo YOKOYAMA, Tokyo (JP)

(73) Assignee: SONY GROUP CORPORATION, Tokyo (JP)

(21) Appl. No.: 18/993,741

(22) PCT Filed: Jul. 6, 2023
(86) PCT No.: PCT/JP2023/025067

§ 371 Date: Jan. 13, 2025

(30) Foreign Application Priority Data
Jul. 21, 2022 (JP) 2022-116211

(51) Int. Cl. G06F 3/03; G06F 3/01

(52) U.S. Cl. CPC G06F 3/03; G06F 3/016

(57) ABSTRACT

The present technology relates to an information processing device and an information processing method capable of suppressing an increase in the number of sensors and improving resolution in position detection in which the number of sensors affects resolution. A position to which a pressure is applied out of a plurality of positions of a plate-shaped body is detected on the basis of a first signal indicating a pressure applied to the plate-shaped body and a second signal indicating an inclination direction of the plate-shaped body.

### TECHNICAL FIELD

The present technology relates to an information processing device and an information processing method, and more particularly to an information processing device and an information processing method that suppress an increase in the number of sensors and improve resolution in position detection in which the number of sensors affects resolution.

### BACKGROUND ART

Patent Documents 1 and 2 disclose technologies in which a user perceives an event and the like occurred by using tactile information such as vibration.

### CITATION LIST

### Patent Document

Patent Document 1: Japanese Patent Application Laid-Open No. 2018-201816

Patent Document 2: Japanese Patent Application Laid-Open No. 2015-185167

### SUMMARY OF THE INVENTION

### Problems to be Solved by the Invention

For example, in a case where a large number of sensors are arranged on the floor to detect a position of a user, and an actuator at the detected position is vibrated to present tactile information to the user, if the number of sensors is increased in order to detect the position of the user with high resolution, a cost increases.

The present technology has been made in view of such a situation, and an object thereof is to suppress an increase in the number of sensors and improve resolution in position detection in which the number of sensors affects resolution.

### Solutions to Problems

An information processing device according to a first aspect of the present technology is an information processing device including a processing unit configured to detect a position to which a pressure is applied out of a plurality of positions of a plate-shaped body on the basis of a first signal indicating a pressure applied to the plate-shaped body and a second signal indicating an inclination direction of the plate-shaped body.

An information processing method according to a first aspect of the present technology is an information processing method in which a processing unit of an information processing device including the processing unit detects a position to which a pressure is applied out of a plurality of positions of a plate-shaped body on the basis of a first signal indicating a pressure applied to the plate-shaped body and a second signal indicating an inclination direction of the plate-shaped body.

In the information processing device and the information processing method according to the first aspect of the present technology, a position to which a pressure is applied out of a plurality of positions of a plate-shaped body is detected on the basis of a first signal indicating a pressure applied to the plate-shaped body and a second signal indicating an inclination direction of the plate-shaped body.

An information processing device according to a second aspect of the present technology is an information processing device including a plate-shaped body, a first sensor configured to output a first signal indicating a pressure applied to the plate-shaped body, and a second sensor configured to output a second signal indicating an inclination direction of the plate-shaped body.

In the information processing device according to the second aspect of the present technology, the first signal indicating the pressure applied to the plate-shaped body is output, and the second signal indicating the inclination direction of the plate-shaped body is output.

### BRIEF DESCRIPTION OF DRAWINGS

FIG. 1 is an external view illustrating a configuration of a tactile presentation plate to which the present technology is applied.

FIG. 2 is a perspective view illustrating a configuration of a tactile presentation module group.

FIG. 3 is a cross-sectional view illustrating the configuration of the tactile presentation module.

FIG. 4 is a diagram illustrating nine stepping positions that can be specified by a gyro sensor.

FIG. 5 is a diagram illustrating a detection result of each tactile presentation module in a case where a user performs stepping.

FIG. 6 is a diagram used for describing an embodiment of stepping detection processing.

FIG. 7 is a diagram used for describing an embodiment of inclination detection processing.

FIG. 8 is a diagram used for describing an embodiment of inclination detection processing.

FIG. 9 is a diagram used for describing an embodiment of offset removal processing.

FIG. 10 is a diagram used for describing an embodiment of offset removal processing.

FIG. 11 is a diagram used for describing an embodiment of offset removal processing.

FIG. 12 is a diagram used for describing an embodiment of vibration presentation processing.

FIG. 13 is a diagram used for describing an embodiment of vibration presentation processing.

FIG. 14 is a diagram used for describing an embodiment of vibration presentation processing.

FIG. 15 is a diagram used for describing an embodiment of video presentation processing.

FIG. 16 is a diagram used for describing an embodiment of video presentation processing.

FIG. 17 is a diagram used for describing an embodiment of video presentation processing.

FIG. 18 is a diagram used for describing a timing of vibration presentation.

FIG. 19 is a configuration diagram illustrating a configuration example of a tactile presentation system.

FIG. 20 is a functional block diagram illustrating a functional configuration of the tactile presentation module.

FIG. 21 is a flowchart illustrating a processing procedure of the tactile presentation system.

### MODE FOR CARRYING OUT THE INVENTION

Hereinafter, an embodiment of the present technology will be described with reference to the drawings.

### Tactile Presentation Plate Regarding Present Embodiment

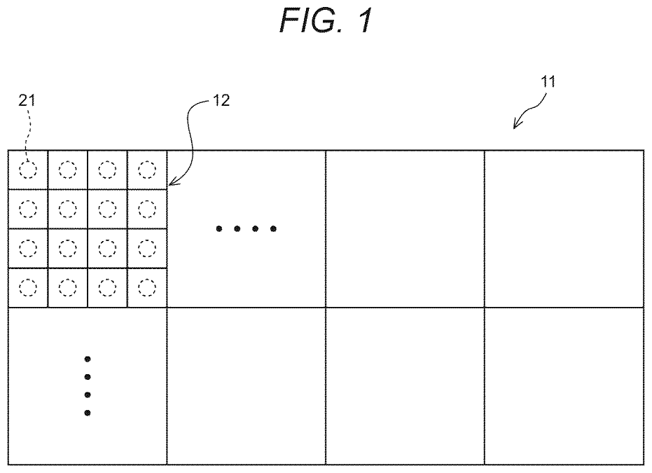

FIG. 1 is an external view illustrating a configuration of a tactile presentation plate to which the present technology is applied. In FIG. 1, a tactile presentation plate 11 is formed into a plate shape and is arranged on a floor surface (ground). The tactile presentation plate 11 arranged on the floor surface presents tactile information to a contact portion of a person, an animal and the like (hereinafter, referred to as a user) standing thereon. The presented tactile information is, for example, vibration, and a type of the vibration (frequency, frequency distribution, strength and the like) is changed depending on an assumed environment. The assumed environment is an environment having different ground conditions such as snowfield and grassland. The type of the vibration is changed depending on a type of the ground. For example, when a user walks on the tactile presentation plate 11, the vibration that gives a tactile sense as if the user is walking on snow, grass, soil, concrete or the like, which is the type of the ground corresponding the assumed environment, is presented to the sole, which is the contact portion between the tactile presentation plate 11 and the user. Note that, the presented tactile information may be temperature or the like.

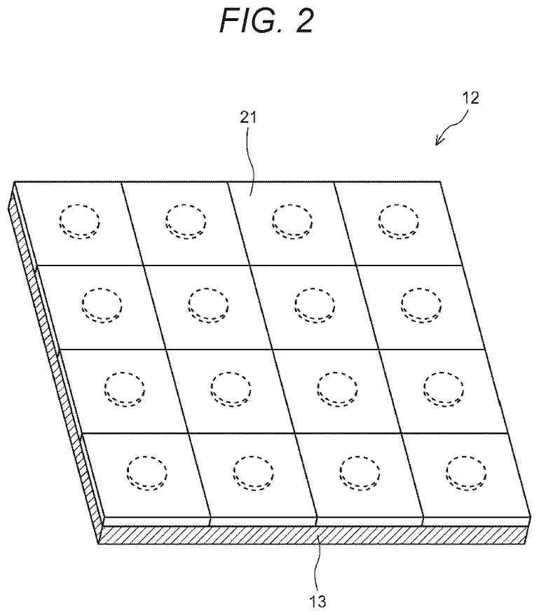

The tactile presentation plate 11 includes a tactile presentation module group 12. The tactile presentation module group 12 is an assembly of a plurality of tactile presentation modules 21 having the same structure, and has a configuration in which a plurality of tactile presentation modules 21 is arranged in front, back, left, and right. FIG. 2 is a perspective view illustrating a configuration of the tactile presentation module group 12 while extracting a part of the tactile presentation plate 11. In FIG. 2, the tactile presentation module group 12 has a configuration in which rectangular tactile presentation modules 21 are fixed to be arranged on an upper surface of an integral plate-shaped body 13 in front, rear, left, and right directions substantially without a gap. The plate-shaped body 13 is, for example, a member integrally formed over an entire tactile presentation plate 11, and may be an elastically deformable member or a plastically deformable member. Furthermore, the plate-shaped body 13 may be the floor itself on which the tactile presentation module group 12 is installed. Note that, the arrangement of the tactile presentation modules 21 is not limited to a specific form. Furthermore, although 4×4 (=16) tactile presentation modules 21 are illustrated in FIG. 2, the number of tactile presentation modules 21 forming the tactile presentation module group 12 is not limited to the specific number. Furthermore, an entire tactile presentation plate 11 may include one tactile presentation module group 12, or may include a plurality of tactile presentation module groups 12.

Each tactile presentation module 21 of the tactile presentation module group 12 generates vibration when detecting that a pressure is applied thereon. For example, in a case where the user walks on the tactile presentation plate 11, the tactile presentation module 21 at a position stepped on by the user detects the pressure, and generates the vibration of a type corresponding to the assumed environment. Therefore, the tactile information is presented on the foot (sole) of the user, and the user is provided with a sense as if the user is walking in the assumed environment.

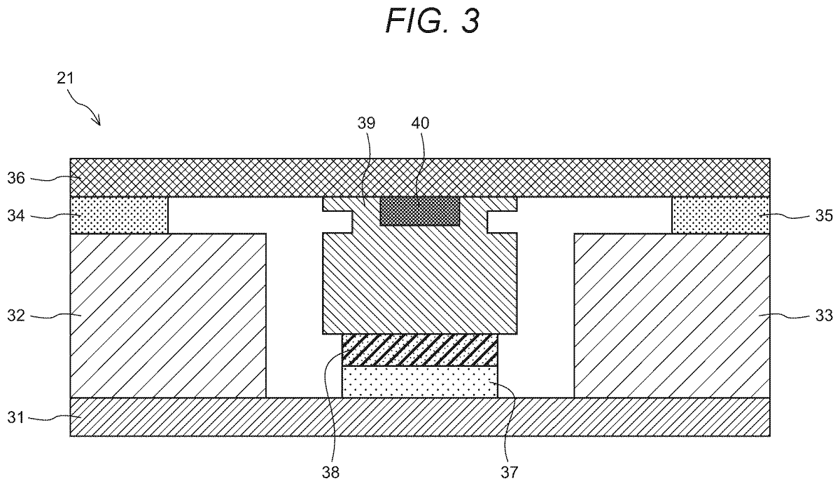

FIG. 3 is a cross-sectional view illustrating the configuration of the tactile presentation module 21. In FIG. 3, the tactile presentation module 21 includes a bottom plate 31, frames 32 and 33, gel portions 34 and 35, a top plate 36, a pressure-sensitive sensor 37, a sponge portion 38, a vibration actuator 39, and a gyro sensor 40. The bottom plate 31 is formed into a rectangular thin plate shape and forms a bottom portion (bottom surface) of the tactile presentation module 21. The frames 32 and 33 are fixed on an upper surface side of the bottom plate 31. The frames 32 and 33 form a bottom surface side of a side wall (side surface) of the tactile presentation module 21. The frames 32 and 33 may be members integrally formed annularly along four side surfaces of the tactile presentation module 21, or may be separate members partially arranged at positions along the side surfaces of the tactile presentation module 21. The gel portions 34 and 35 are entirely or partially fixed to upper surfaces of the frames 32 and 33.

The gel portions 34 and 35 form an upper surface side of the side wall (side surface) of the tactile presentation module 21. The gel portions 34 and 35 may be members integrally formed annularly along four side surfaces of the tactile presentation module 21, or may be separate members partially arranged at positions along the side surfaces of the tactile presentation module 21. The gel portions 34 and 35 are formed using gel. The gel is a substance having both viscosity (liquid property) and elasticity (solid property). The gel portions 34 and 35 have smaller rigidity (Young's modulus) as compared with the bottom plate 31, the frames 32 and 33, and the top plate 36, a material of which is not particularly specified, and are easily deformed by an external force. However, as compared with the sponge portion 38, the gel portions 34 and 35 have a larger Young's modulus and are hardly deformed by the external force. The top plate 36 is fixed to the upper surfaces of the gel portions 34 and 35.

The top plate 36 is formed into a rectangular thin plate shape, arranged so as to be opposed to the bottom plate 31, and forms au upper portion (upper surface) of the tactile presentation module 21. Note that, the top plate 36 also acts as a diaphragm that presents vibration to the user. A pressure-sensitive sensor 37 is fixed to the upper surface of the bottom plate 31. The pressure-sensitive sensor 37 is arranged in a space formed between the frames 32 and 33. The pressure-sensitive sensor 37 outputs a detection signal (pressure value) of a voltage corresponding to an externally applied pressure. The sponge portion 38 is fixed to an upper surface of the pressure-sensitive sensor 37. The sponge portion 38 is formed using a sponge. The sponge is a porous soft substance. As compared with the gel portions 34 and 35, the sponge portion 38 has a smaller Young's modulus and are easily deformed by the external force. The vibration actuator 39 is fixed to an upper surface of the sponge portion 38. An upper surface of the vibration actuator 39 is fixed to the top plate 36. Note that, they are fixed in such a manner that the center of the upper surface of the vibration actuator 39 and the plate surface center of the top plate 36 substantially coincide with each other.

The vibration actuator 39 generates vibration corresponding to a waveform of a supplied voltage signal. The vibration generated by the vibration actuator 39 is propagated to the top plate 36 to vibrate the top plate 36. A concave portion is formed at the center of the upper surface of the vibration actuator 39, and the gyro sensor 40 is arranged in the concave portion. Note that, the gyro sensor 40 may be fixed to the vibration actuator 39 or may be fixed to a lower surface of the top plate 36. The gyro sensor 40 outputs a detection signal of a voltage corresponding to an angular velocity around each of two axes orthogonal to each other along the upper surface to the top plate 36. Note that, the gyro sensor 40 may be a sensor that detects angular velocities around three orthogonal axes, and in this case, one axis is set in a direction orthogonal to the top plate 36.

According to the tactile presentation module 21 of FIG. 3, when the top plate 36 is stepped on by the user's foot and a pressure is applied to the top plate 36, a part of a pressure F is applied to the pressure-sensitive sensor 37 via the vibration actuator 39 and the sponge portion 38. Therefore, it is possible to detect whether or not the pressure is applied to the top plate 36 and magnitude of the applied pressure on the basis of the detection signal of the pressure-sensitive sensor 37. Note that, the following description will be given assuming that the pressure applied to the top plate 36 is mainly the pressure due to stepping of the user (foot). Note that, in the present technology, a cause of generation of the pressure applied to the top plate 36 may be pressing with a hand, a tool and the like, and is not limited to a specific case.

Furthermore, most of the pressure F applied to the top plate 36 is received by the gel portions 34 and 35. Therefore, since a pressure f applied to the pressure-sensitive sensor 37 is limited to a part of the pressure F applied to the top plate 36, an upper limit of a pressure-sensitive range of the pressure-sensitive sensor 37 can be made sufficiently smaller than an assumed maximum weight of the user. Therefore, a low-cost sensor can be used as the pressure-sensitive sensor 37. Furthermore, a degree of influence on ease of movement of the vibration actuator 39 (ease of vertical movement of the top plate 36) is small.

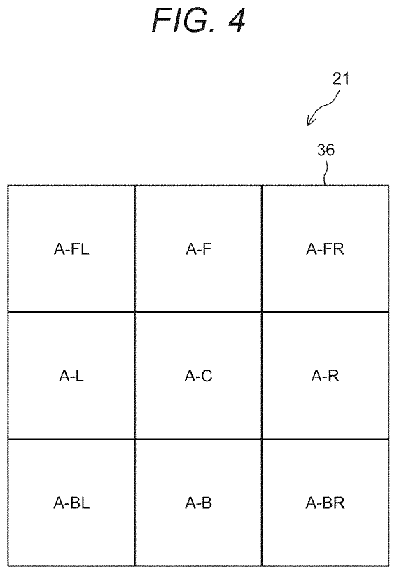

Furthermore, according to the tactile presentation module 21 of FIG. 3, the gyro sensor 40 arranged in the vicinity of the center of the top plate 36 measures an inclination (angle of about 3 degrees or smaller) generated in the top plate 36. By measuring a direction in which the top plate 36 is inclined by the gyro sensor 40 when the user's stepping is detected by the pressure-sensitive sensor 37, a stepping position can be estimated with 9-resolution. The 9-resolution means that it is possible to specify which position of the positions (regions) obtained by dividing the top plate 36 into nine parts is the stepping position. FIG. 4 is a diagram illustrating nine stepping positions that can be specified by the gyro sensor 40. In FIG. 4, the tactile presentation module 21 is illustrated in a top view as viewed from the top plate 36 side, and an entire plate surface of the top plate 36 is divided into nine sections of regions A-FL, A-F, A-FR, A-L, A-C, A-R, A-BL, A-B, and A-BR in a grid shape. The regions A-FL, A-F, A-FR, A-L, A-C, A-R, A-BL, A-B, and A-BR represent stepping positions that can be specified by the gyro sensor 40, and are also referred to as a left front position A-FL, a front position A-F, a right front position A-FR, a left position A-L, a center position A-C, a right position A-R, a left rear position A-BL, a rear position A-B, and a right rear position A-BR, respectively. Note that, the estimation (specifying) of the stepping position with respect to the top plate 36 by the gyro sensor 40 is not limited to the 9-resolution.

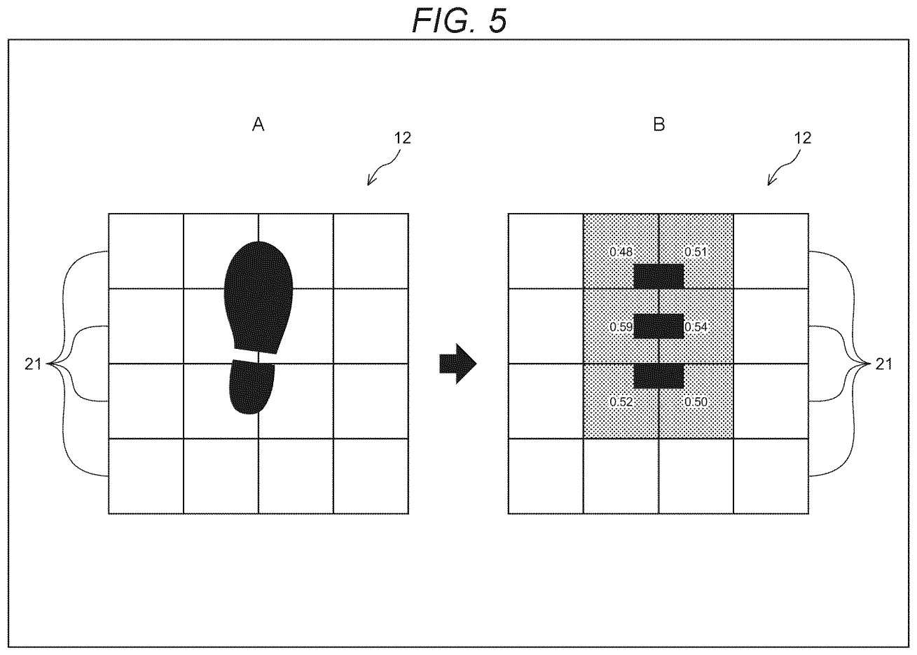

FIG. 5 is a diagram illustrating a detection result of each tactile presentation module 21 in a case where the user performs stepping in the tactile presentation module group 12 including 4×4 tactile presentation modules 21. In the tactile presentation module group 12 in A of FIG. 5, it is assumed that a user steps on a stepping position indicated by a shoe trace. At that time, as illustrated in the tactile presentation module group 12 in B of FIG. 5, it is assumed that, in a total of six tactile presentation modules 21, which are first to third tactile presentation modules from the top in second and third columns from the left, the pressure-sensitive sensors 37 output pressure values of 0.48, 0.59, 0.52, 0.51, 0.54, and 0.50, respectively, as detection signals. Note that, it is assumed that the pressure-sensitive sensors 37 of the other tactile presentation modules 21 output a pressure value of about 0 as the detection signal. By detecting the tactile presentation module 21 in which the pressure-sensitive sensor 37 outputs the detection signal of the pressure value of a certain value or larger, the tactile presentation module 21 stepped on by the user is detected.

Furthermore, in the tactile presentation module 21 stepped on by the user, the direction of the inclination of the top plate 36 is detected on the basis of the detection signal of the gyro sensor 40, so that the stepping position in each tactile presentation module 21 is specified to one of the nine regions A-FL, A-F, A-FR, A-L, A-C, A-R, A-BL, A-B, and A-BR. B of FIG. 5 illustrates a case where a region indicated by solid black is detected as the stepping position. For example, in the first to third tactile presentation modules 21 from the top in the second column from the left, a case where the right rear position A-BR, the right position A-R, and the right front position A-FR are detected as the stepping positions, respectively, are illustrated.

In this manner, by using the two sensors, not only the tactile presentation module 21 stepped on by the user is detected, but also the stepping position in the tactile presentation module 21 (top plate 36) is specified to one of the nine regions, moreover, so that one tactile presentation module 21 can detect the stepping position with 9-resolution. That is, since the position detection with 9-resolution can be performed only by the two sensors (pressure-sensitive sensor 37 and gyro sensor 40), the resolution can be improved without increasing the number of sensors.

### <Stepping Detection Processing>

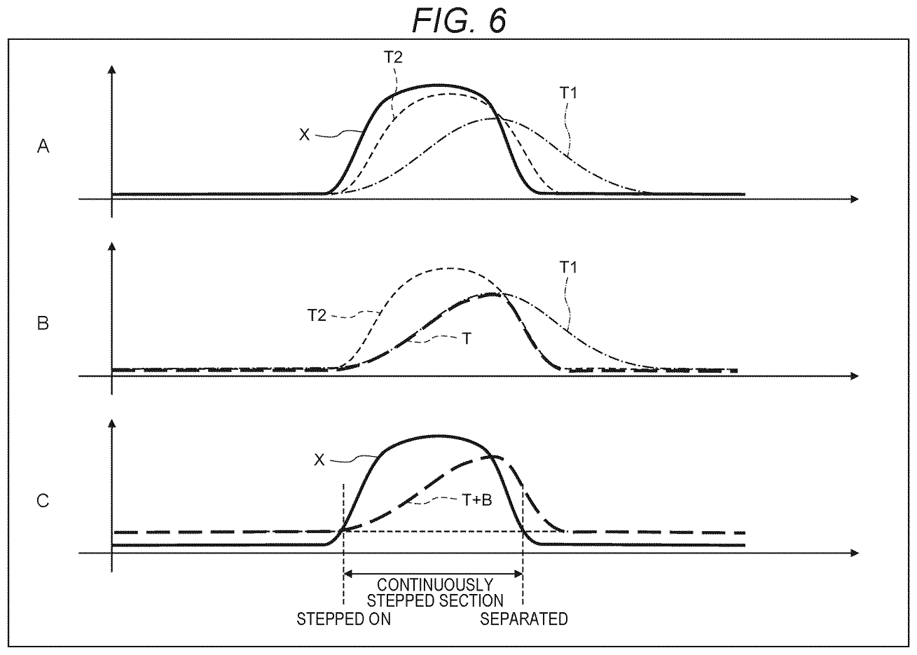

The stepping detection processing is processing of detecting stepping of the user by the pressure-sensitive sensor 37 of the tactile presentation module 21 (processing of detecting whether or not stepping is performed). An embodiment of the stepping detection processing will be described with reference to FIG. 6. In A to C of FIG. 6, time is plotted along the abscissa, and a signal value (pressure value) is plotted along the ordinate. In A of FIG. 6, a detection signal X is an example of a detection signal output from the pressure-sensitive sensor 37 during a certain period of time. A signal T1 represents a signal after the detection signal X is subjected to filter processing by a low-pass filter of a cutoff frequency A1, and is expressed by a function LPF(X,A1). A signal T2 represents a signal after the detection signal X is subjected to filter processing by a low-pass filter of a cutoff frequency A2, and is expressed by a function LPF(X,A2). Note that, it is assumed that A1<A2.

As a simple embodiment of the stepping detection processing, it is determined whether or not the value of the detection signal X is equal to or larger than a predetermined threshold, thereby detecting whether or not the stepping is performed. Note that, the detection signal X includes, as noise, displacement of the top plate 36 or the like caused by vibration of the vibration actuator 39. Furthermore, an initial value of the detection signal X and a value of the detection signal X in a case where the same pressure is applied to the top plate 36 are different for each tactile presentation module 21 due to a manufacturing error for each tactile presentation module 21, a secular change in physical properties of the gel portions 34 and 35 and the like. Therefore, in the example of the stepping detection processing using the predetermined threshold, detection accuracy is low. Therefore, in the present embodiment of the stepping detection processing, the noise included in the detection signal X is removed and an individual difference of the value of the detection signal X is alleviated by performing the filter processing of the low-pass filter on the detection signal X. Furthermore, a threshold at which it is determined that the stepping has been performed is sequentially updated as follows.

In A of FIG. 6, a signal T1=LPF(X,A1) and a signal T2=LPF(X,A2) obtained by the filter processing on the detection signal X are illustrated in B of FIG. 6. In B of FIG. 6, the detection signal T represents a signal generated with a smaller value of values of the signals T1 and T2 at each timing, and is represented by a function MIN(T1, T2). At that time, the threshold for determining that the stepping has been performed is updated with a lapse of time by a signal (threshold) T+B=function MIN(T1,T2)+B as illustrated in C of FIG. 6. Here, B represents a predetermined constant value. In C of FIG. 6, it is determined that the stepping is not performed while the detection signal X is smaller than the threshold T+B. In a case where the detection signal X is equal to or larger than the threshold T+B, it is determined that the stepping has been performed. Note that, the threshold T+B at that time is set as T0+B. In a case where the detection signal X becomes smaller than the threshold T0+B after it is determined that the stepping has been performed (the user has stepped on), it is determined that the stepping has been released (the user's foot has been separated). Note that, the threshold for determining that the stepping is released may be the threshold T+B instead of T0+B.

The embodiment of the stepping detection processing described above with reference to FIG. 6 is an example, and the present invention is not limited thereto. For example, the threshold for determining that the stepping has been performed may be sequentially updated, and a parameter used for the update may be switched depending on the state (for example, the cutoff frequency of the low-pass filter is changed in response to the detection signal X exceeding or falling below the threshold).

### <Inclination Detection Processing (Stepping Position Detection Processing)>

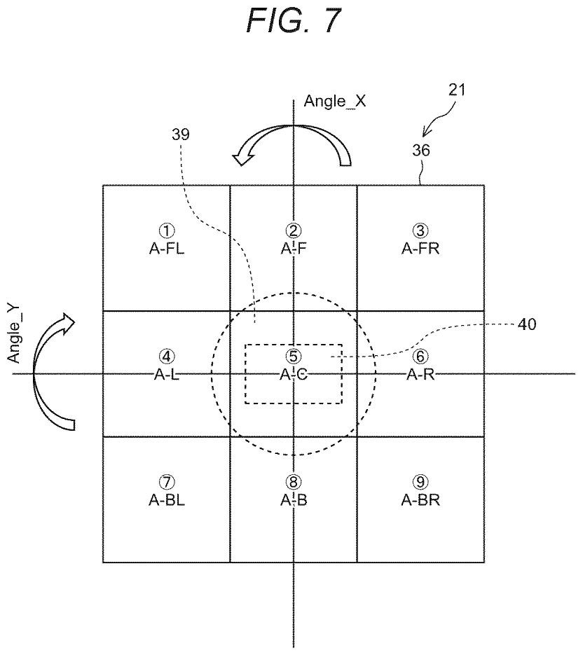

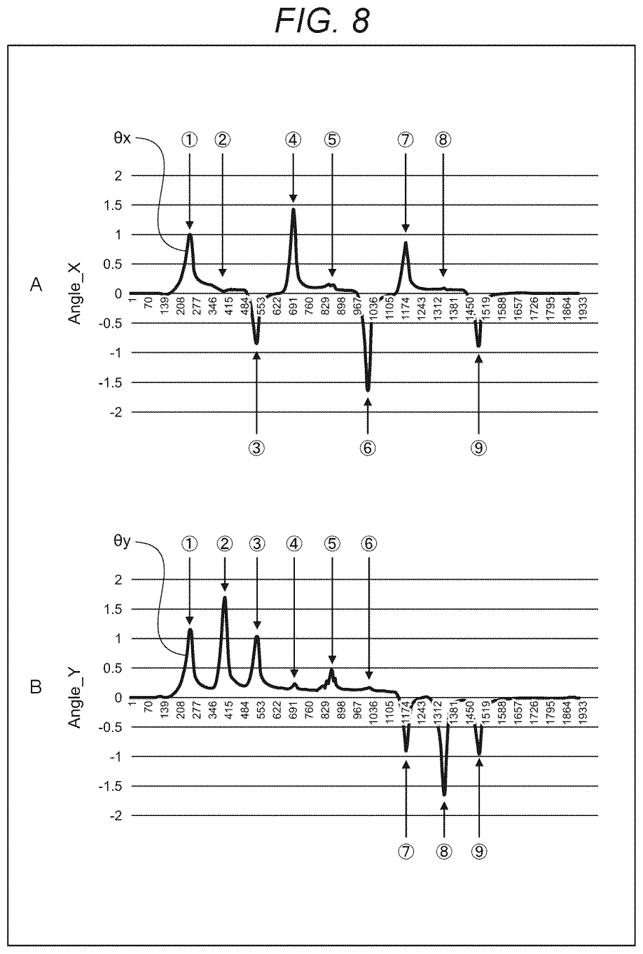

The inclination detection processing is processing of detecting the inclination (stepping position) of the top plate 36 by the gyro sensor 40 of the tactile presentation module 21. An embodiment of the inclination detection processing will be described with reference to FIGS. 7 and 8. Note that, the stepping position of the top plate 36 of the tactile presentation module 21 by the user is also simply referred to as a stepping position of the tactile presentation module 21.

In FIG. 7, on the top plate 36 of the tactile presentation module 21, nine stepping positions that can be specified by the gyro sensor 40 are indicated as nine regions A-FL, A-F, A-FR, A-L, A-C, A-R, A-BL, A-B, and A-BR as in FIG. 4. Note that, the respective regions are assigned with numbers 1 to 9 (numbers indicated by circled numbers), and the respective regions are appropriately identified using the numbers assigned to the respective regions.

The gyro sensor 40 is fitted into the concave portion formed on the upper surface of the vibration actuator 39 and is arranged at the central portion of the top plate 36. The gyro sensor 40 is directly fixed to a back surface of the top plate 36 or indirectly fixed thereto via the gyro sensor 40 so as to be inclined in conjunction with the top plate 36. The gyro sensor 40 has an X axis and a Y axis orthogonal to each other, and the gyro sensor 40 is fixed to the top plate 36 in such a manner that the X axis and the Y axis are both in a direction along the plate surface of the top plate 36 and parallel to the side of a quadrangular top plate 36. The gyro sensor 40 outputs, as detection signals, a signal of a voltage (angular velocity signal) corresponding to the angular velocity around the X axis and a signal of a voltage (angular velocity signal) corresponding to the angular velocity around the Y axis. Note that, it is assumed that the angular velocity signal is subjected to integration processing by internal processing of the gyro sensor 40 or processing in an external processing unit, and an angle signal θx (signal value Angle_X) of a voltage corresponding to a rotation angle around the X axis and an angle signal θy (signal value Angle_Y) of a voltage corresponding to a rotation angle around the Y axis are output by the gyro sensor 40.

A and B of FIG. 8 are diagrams illustrating the angle signal θx and the angle signal θy output from the gyro sensor 40 in a case where a pressure is sequentially applied to the regions 1 to 9 of FIG. 7, respectively. In these drawings, the timings of the numbers 1 to 9 (the numbers indicated by circled numbers) indicated by arrows with respect to the angle signal θx and the angle signal θy represent the timings at which the pressure is applied to the regions 1 to 9 of the tactile presentation module 21.

According to this, for example, when a pressure is applied to the left front position A-FL, which is the first region of the tactile presentation module 21, the angle signal θx and the angle signal θy indicate positive values, respectively. Note that, the positive value means a positive value equal to or larger than a predetermined threshold. That is, in a case where the angle signal θx is a positive value, the top plate 36 is in a state inclined in such a manner that a left side is lower than a right side with respect to the x axis, and in a case where the angle signal θy is a positive value, the top plate 36 is in a state inclined in such a manner that a front side is lower than a rear side with respect to the y axis. Therefore, in a case where the angle signal θx and the angle signal θy are the positive values, since the left front position A-FL of the top plate 36 is displaced downward, it is detected that the pressure is applied to the left front position A-FL. For example, when a pressure is applied to the front position A-F, which is the second region of the tactile presentation module 21, the angle signal θx and the angle signal θy indicate a zero value and a positive value, respectively. Note that, the zero value means a value about 0 equal to or smaller than a predetermined threshold. That is, in a case where the angle signal θx is the zero value, the top plate 36 is in a state not inclined in such a manner that the left side and the right side are at the same height with respect to the x axis, and in a case where the angle signal θy is the positive value, the top plate 36 is in a state inclined in such a manner that the front side is lower than the rear side with respect to the y axis. Therefore, in a case where the angle signal θx and the angle signal θy are the zero value and the positive value, respectively, since the front position A-F of the top plate 36 is displaced downward, it is detected that the pressure is applied to the front position A-F.

For example, when a pressure is applied to the center position A-C, which is the fifth region of the tactile presentation module 21, the angle signal θx and the angle signal θy indicate the zero value, respectively. That is, in a case where the angle signal θx is the zero value, the top plate 36 is in a state not inclined in such a manner that the left side and the right side are at the same height with respect to the x axis, and in a case where the angle signal θy is the zero value, the top plate 36 is in a state not inclined in such a manner that the front side and the rear side are at the same height with respect to the y axis. In a case where the angle signal θx and the angle signal θy are the zero values, respectively, there might be a case where no pressure is applied to the tactile presentation module 21. Note that, under a situation in which the stepping of the tactile presentation module 21 is detected by the detection signal of the pressure-sensitive sensor 37, since the center position A-C of the top plate 36 is displaced downward, it is detected that the pressure is applied to the center position A-C. For example, when a pressure is applied to the right rear position A-BR, which is the ninth region of the tactile presentation module 21, the angle signal θx and the angle signal θy indicate negative values, respectively. Note that, the negative value means a negative value equal to or smaller than a predetermined threshold. That is, in a case where the angle signal θx is the negative value, the top plate 36 is in a state inclined in such a manner that the right side is lower than the left side with respect to the x axis, and in a case where the angle signal θy is the negative value, the top plate 36 is in a state inclined in such a manner that the rear side is lower than the front side with respect to the y axis. Therefore, in a case where the angle signal θx and the angle signal θy are the negative values, respectively, since the right rear position A-BR of the top plate 36 is displaced downward, it is detected that the pressure is applied to the right rear position A-BR.

As in these examples, the angle signals θx and θy can take three forms of the positive value, zero value, and negative value. Therefore, there are nine combinations of the three forms of the angle signal θx and the three forms of the angle signal θy, and by detecting which of the nine combinations, it is possible to detect to which region of the nine regions of the top plate 36 the pressure is applied.

### <Offset Removal Processing of Gyro Sensor 40>

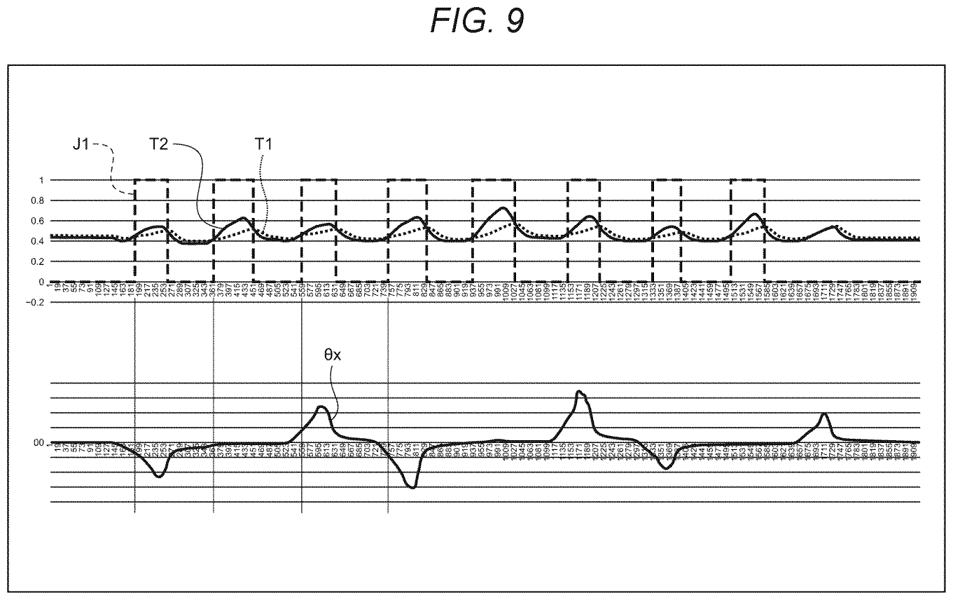

Offset removal processing of the gyro sensor 40 is processing of removing an offset included in the detection signal output from the gyro sensor 40. An embodiment of the offset removal processing will be described with reference to FIGS. 9 to 11. On an upper side of FIG. 9, the signal T1=LPF(X,A1) and the signal T2=LPF(X,A2) after the detection signal X output from the pressure-sensitive sensor 37 is subjected to the filter processing by the low-pass filter as in FIG. 6 are illustrated, with time plotted along the abscissa and a signal value plotted along the ordinate. A binary signal (stepping determination signal J1) including a high value and a low value indicated in superposition with the signals T1 and T2 indicates that it is determined that the stepping is not performed in a period of the low value and it is determined that the stepping is performed in a period of the high value by the stepping detection processing described above. On a lower side of FIG. 9, the detection signal (angle signal θx) output from the gyro sensor 40 is illustrated, with time corresponding to the abscissa of the graph on the upper side plotted along the abscissa and a signal value plotted along the ordinate. According to this, at a start time point of a period in which the stepping is detected, that is, the period in which the stepping determination signal J1 is the high value, the top plate 36 is not sufficiently inclined, so that in a case where the value of the angle signal θx is small and the angle signal θx includes an offset component, if the stepping position of the top plate 36 is specified from the value of the angle signal θx (and the angle signal θy) at that time, there is a possibility of erroneous detection.

In contrast, each tactile presentation module 21 is one of many of them, and a time in which the stepping is not performed is extremely longer than a time in which the stepping is performed. Therefore, regardless of whether or not the stepping is detected or in a period in which the stepping is not detected, a correction amount is added to the angle signal θx so that the value of the angle signal θx gradually or stepwise approaches 0 with a lapse of time, and the value is set as the value of the angle signal θx. The correction amount is a value that is always added as a component of the angle signal θx regardless of whether or not the stepping is detected, and the correction amount is gradually or stepwise updated with a lapse of time so as to reduce the offset component. Therefore, an offset of the angle signal θx can be removed. The offset of the angle signal θy can be removed similarly to the angle signal 0x. Furthermore, in the embodiment of the above-described inclination detection processing, a case has been described in which the detection of the stepping position is performed depending on which combination of the positive value, zero value, and negative value, the angle signals θx and θy are. In contrast, the stepping position can also be specified by angular velocity signals ωx and ωy around the X axis and the Y axis obtained by differentiating the angle signals θx and θy, respectively. Note that, the angular velocity signals ωx and ωy are detection signals originally output by the gyro sensor 40, and correspond to detection signals before being subjected to integration processing in order to output the angle signals θx and θy.

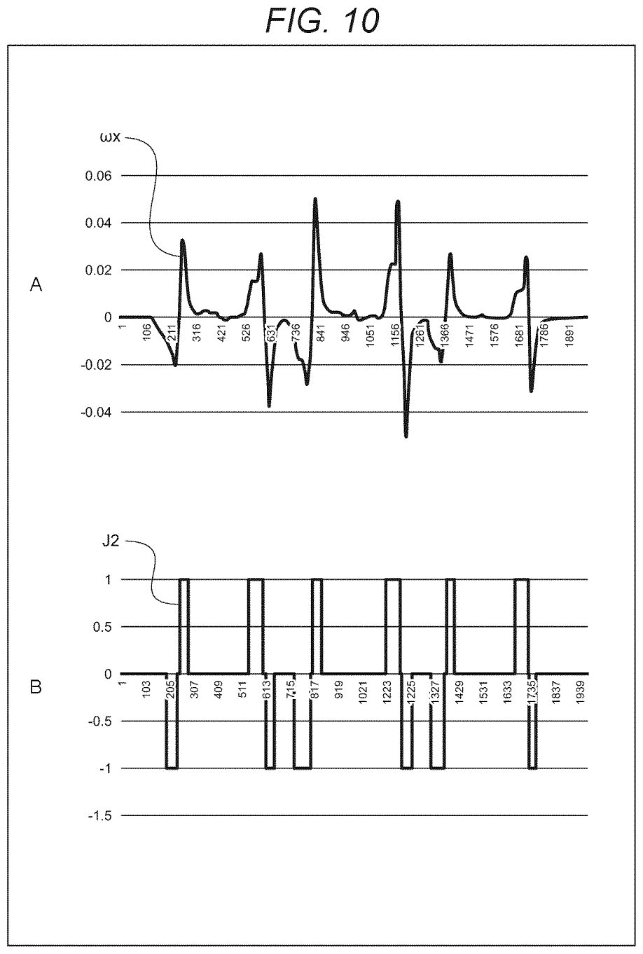

On an upper side of FIG. 10, the angular velocity signal ωx output from the gyro sensor 40 is illustrated, with time plotted along the abscissa and a signal value plotted along the ordinate. On a lower side of FIG. 10, a ternary signal (rotation direction determination signal J2) including a center value, a high value, and a low value (high value>center value>low value) is illustrated, with a time corresponding to the time on the upper side plotted along the abscissa and a signal value plotted along the ordinate. The rotation direction determination signal J2 indicates that the angular velocity signal ωx is determined to be a zero value during a center value period, the angular velocity signal ωx is determined to be a positive value during a high value period, and the angular velocity signal ωx is determined to be a negative value during a low value period. Here, the zero value, the positive value, and the negative value have the meanings similar to the zero value, the positive value, and the negative value used for the angle signals θx and θy. In a case where the rotation direction determination signal J2 is the center value, this indicates that the angle signal θx is in a constant state. In a case where the rotation direction determination signal J2 is a high value, this indicates that the angle signal θx is changing in a positive value direction. In a case where the rotation direction determination signal J2 is a low value, this indicates that the angle signal θx is changing in a negative value direction. For the angular velocity signal ωy, a rotation direction determination signal is obtained similarly to the angular velocity signal ωx.

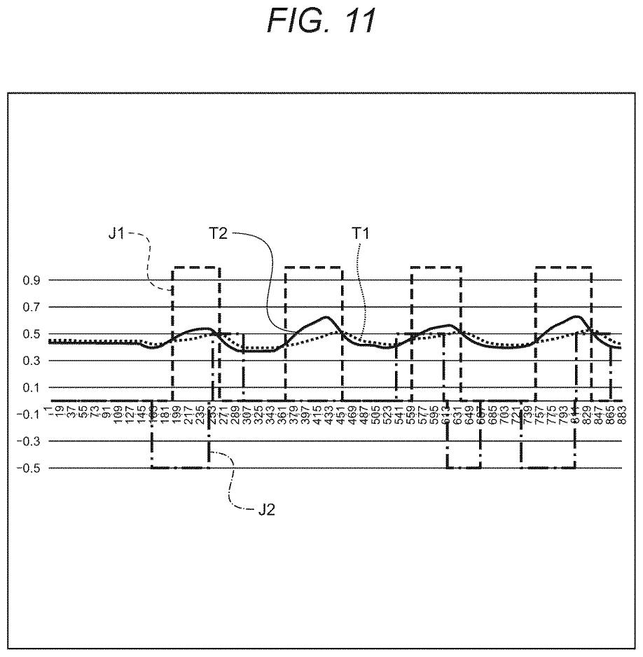

FIG. 11 illustrates the signals T1 and T2, stepping determination signal J1, and rotation direction determination signal J2 in a part of the period of FIG. 9 in an overlapping manner. According to this, a changing direction of the angle signal θx at a time point when the stepping determination signal J1 changes from the low value to the high value (the start time point of the high value period) is detected by the value of the rotation direction determination signal J2. The change direction of the angle signal θy is similarly detected. Therefore, the stepping position can be specified in any of the nine regions of the top plate 36. In a case of performing such inclination detection processing, since the angular velocity signals ωx and ωy also include the offset components, the offset removal processing is performed similarly to the case of the angle signal θx. That is, regardless of whether or not the stepping is detected or in a period in which the stepping is not detected, a correction amount is added to the angular velocity signal ωx so that the value of the angular velocity signal ωx gradually or stepwise approaches 0 with a lapse of time, and the value is set as the value of the angular velocity signal x. The correction amount is a value that is always added as a component of the angular velocity signal ωx regardless of whether or not the stepping is detected, and the correction amount is gradually or stepwise updated with a lapse of time so as to reduce the offset component. Therefore, an offset of the angular velocity signal ωx can be removed. The offset of the angular velocity signal ωy can be removed similarly to the angular velocity signal ωx.

Note that, the offset removal processing for the angular velocity signals ωx and ωy can be performed not only in a case of performing the inclination detection processing (specifying the stepping position) by the angular velocity signals ωx and ωy, but also in a case of performing the inclination detection processing by the angle signals θx and θy. In that case, the angle signals θx and θy after the offset removal processing is performed on the angular velocity signals ωx and ωy obtained by the gyro sensor 40 are subjected to integration processing to obtain the angle signals θx and θy. Furthermore, also in a case where the offset removal processing is performed on the angular velocity signals ωx and ωy, the offset removal processing may be performed on the angle signals θx and θy. Furthermore, in the inclination detection processing, a case by the angle signals θx and θy and a case by the angular velocity signals ωx and ωy may be used in combination.

### <Vibration Presentation Processing>

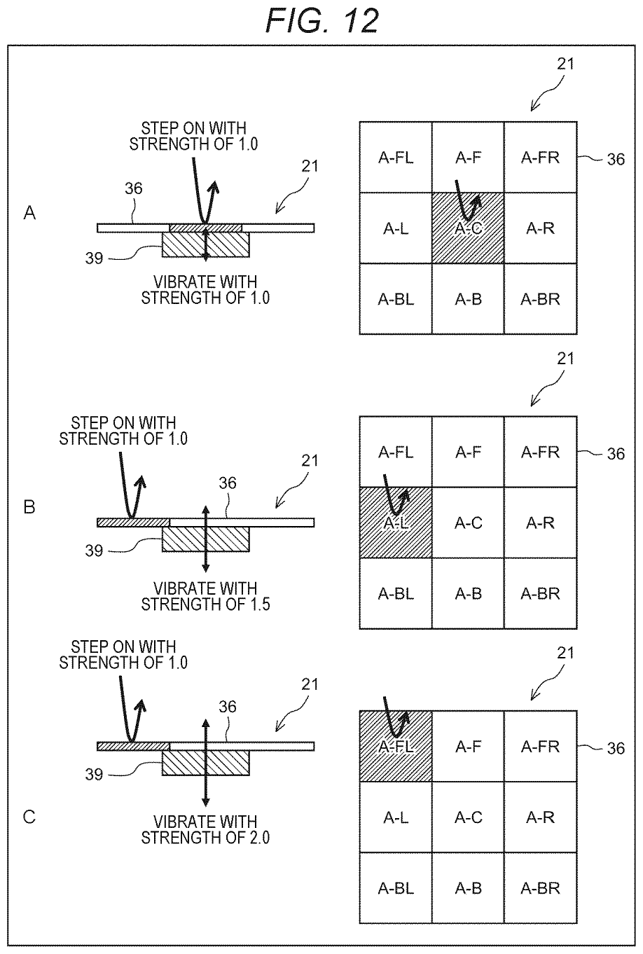

The vibration presentation processing is processing of vibrating the top plate 36 by the vibration actuator 39 of the tactile presentation module 21. An embodiment of the vibration presentation processing will be described with reference to FIGS. 12 to 14. In A, B, and C of FIG. 12, a region where the user performs the stepping on the tactile presentation module 21 (top plate 36) (a stepping position detected by the pressure-sensitive sensor 37 and the gyro sensor 40) is illustrated on a right side in a pattern different from the others. On a left side of each of them, a cross-section of the top plate 36 and the vibration actuator 39 of the tactile presentation module 21 and additional information are illustrated. A of FIG. 12 illustrates a case where the center position A-C of the top plate 36 as a stepping position is stepped on with a strength of 1. The strength of stepping represents magnitude of the pressure detected by the pressure-sensitive sensor 37, and in a case of 0, the pressure is not applied, and the applied pressure is larger as the numerical value increases. It is assumed that the vibration actuator 39 vibrates with a strength of 1 in a case where the center position A-C is stepped on with a strength of 1. It is assumed that when the strength of vibration generated by the vibration actuator 39 is 0, no vibration is generated, and the larger the numerical value is, the larger the vibration is.

Here, the vibration actuator 39 is installed immediately below the center position A-C of the top plate 36, and the vibration generated by the vibration actuator 39 is most easily transmitted to the stepped foot in a region closer to the center position A-C out of the nine regions of the top plate 36. B of FIG. 12 illustrates a case where the left position A-L of the top plate 36 as a stepping position is stepped on with a strength of 1. In this case, the vibration actuator 39 vibrates with a strength of 1.5. Since the left position A-L is farther from the vibration actuator 39 than the center position A-C and the vibration of the vibration actuator 39 is less likely to be transmitted, the strength of the vibration generated by the vibration actuator 39 is set to 1.5 times. As a result, the strength of vibration presented to (perceived by) the foot of the user who steps on the left position A-L with a strength of 1 is equivalent to the strength of vibration presented to (perceived by) the foot of the user who steps on the center position A-C with a strength of 1. Even in a case where each of the front position A-F, the right position A-R, and the rear position A-B is stepped on with a strength of 1, the vibration actuator 39 vibrates with a strength of 1.5.

C of FIG. 12 illustrates a case where the left front position A-FL of the top plate 36 as a stepping position is stepped on with a strength of 1. In this case, the vibration actuator 39 vibrates with a strength of 2.0. Since the left front position A-FL is farther from the vibration actuator 39 than the center position A-C and the left position A-L, and the vibration of the vibration actuator 39 is less likely to be transmitted, the strength of the vibration generated by the vibration actuator 39 is set to 2.0 times. As a result, the strength of vibration presented to (perceived by) the foot of the user who steps on the left front position A-FL with a strength of 1 is equivalent to the strength of vibration presented to (perceived by) the foot of the user who steps on the center position A-C or the left position A-L with a strength of 1. Even in a case where each of the right front position A-FR, the right rear position A-BR, and the left rear position A-BL is stepped on with a strength of 1, the vibration actuator 39 vibrates with a strength of 2.0. Note that, with regard to a case in A of FIG. 12, the strength of vibration in each of cases of B and C of FIG. 12 is set to 1.5 times and 2.0 times, respectively; however, specific numerical values of these magnifications are merely examples, and it is only required that the strength of vibration of the vibration actuator 39 is adjusted depending on the stepping position so that vibration of the same strength is presented to the user's foot stepping on each of the nine regions of the top plate 36 with the same strength.

### EXAMPLE 1

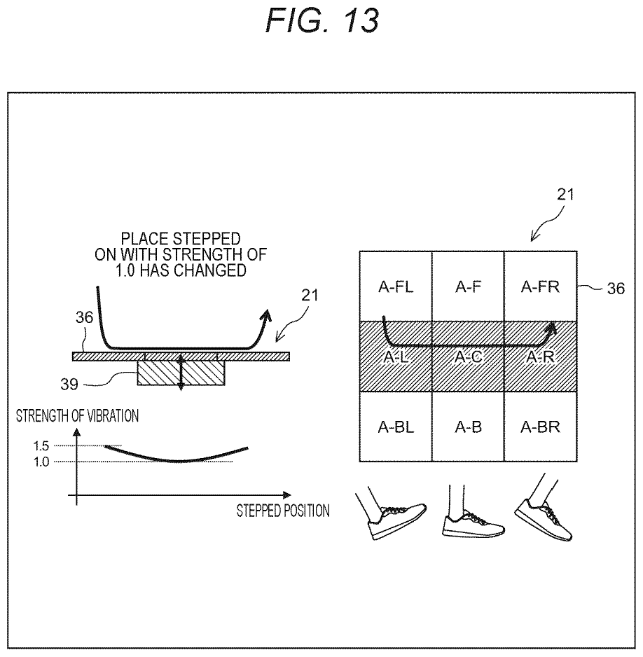

FIG. 13 is an explanatory diagram illustrating Example 1 in a case where vibration presentation processing as illustrated in FIG. 12 is applied. FIG. 13 illustrates a case where a top plate 36 of one tactile presentation module 21 is stepped on with a strength of 1 in the order of a left position A-L, a center position A-C, and a right position A-R. For example, a case is assumed in FIG. 13 where a heel of a user who is walking first steps on the left position A-L, next the center of a sole steps on the center position A-C with forward movement of a body, and finally a toe steps on the right position A-R as in movement of a foot illustrated in FIG. 13. At that time, a strength of vibration of a vibration actuator 39 is changed along a graph line as illustrated in an abstract manner in a lower left graph of FIG. 13. In the lower left graph, a stepping position with respect to the top plate 36 illustrated on the upper left of FIG. 13 is plotted along the abscissa, and the strength of vibration of the vibration actuator 39 is plotted along the ordinate. According to this, when the stepping position changes in the order of the left position A-L, the center position A-C, and the right position A-R, the strength of vibration of the vibration actuator 39 is changed in the order of 1.5, 1, and 1.5 along the graph line. The strength of vibration of the vibration actuator 39 is not only changed by a discrete value, but may also be changed by a continuous value as in the graph line of FIG. 13.

### EXAMPLE 2

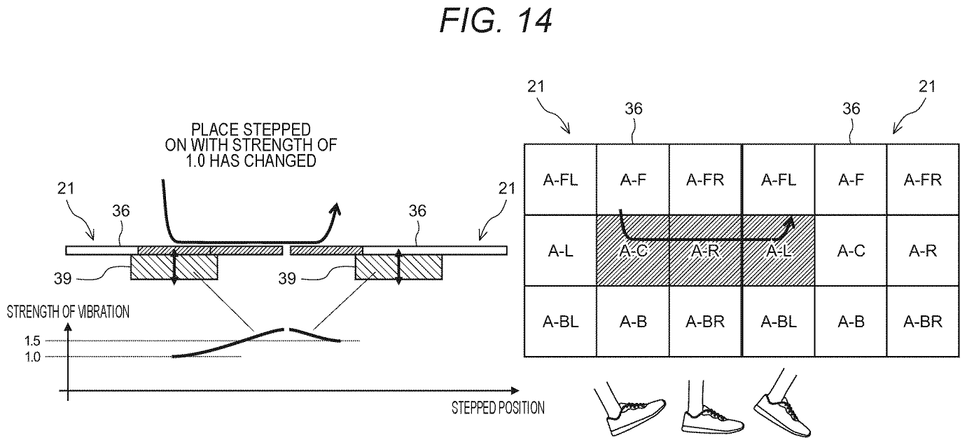

FIG. 14 is an explanatory diagram illustrating Example 2 in a case where vibration presentation processing as illustrated in FIG. 12 is applied. FIG. 14 illustrates a case where top plates 36 of two adjacent tactile presentation modules 21 are stepped on, and illustrates a case where the top plate 36 of one tactile presentation module 21 is stepped on with a strength of 1 in the order of a center position A-C and a right position A-R, and then the top plate 36 of the other tactile presentation module 21 is stepped on with a strength of 1 in a left position A-L. For example, a case is assumed in FIG. 14 where a heel of a user who is walking first steps on the center position A-C of one top plate 36, next the center of a sole steps on the right position A-R of the same top plate 36 with forward movement of a body, and finally a toe steps on the left position A-L of the other top plate 36 as in movement of a foot illustrated in FIG. 14. At that time, a strength of vibration of a vibration actuator 39 is changed along a graph line as illustrated in an abstract manner in a lower left graph of FIG. 14. In the lower left graph, a stepping position with respect to the two adjacent top plates 36 illustrated on the upper left of FIG. 14 is plotted along the abscissa, and the strength of vibration of the vibration actuator 39 is plotted along the ordinate. According to this, when the stepping position changes in the order of the center position A-C and the right position A-R of one (first) top plate 36 (top plate 36 on the left side in the drawing), the strength of vibration of the first vibration actuator 39 (vibration actuator 39 on the left side in the drawing) is changed in the order of 1 and 1.5 along the graph line. Note that, at that time, the other (second) vibration actuator 39 (the vibration actuator 39 on the right side in the drawing) does not vibrate. When the stepping position of the top plate 36 changes to the left position A-L of the second top plate 36 (the top plate 36 on the right side in the drawing), the strength of vibration of the second vibration actuator 39 is changed to 1.5 along the graph line. Note that, at that time, the first vibration actuator 39 does not vibrate.

### <Video Presentation Processing>

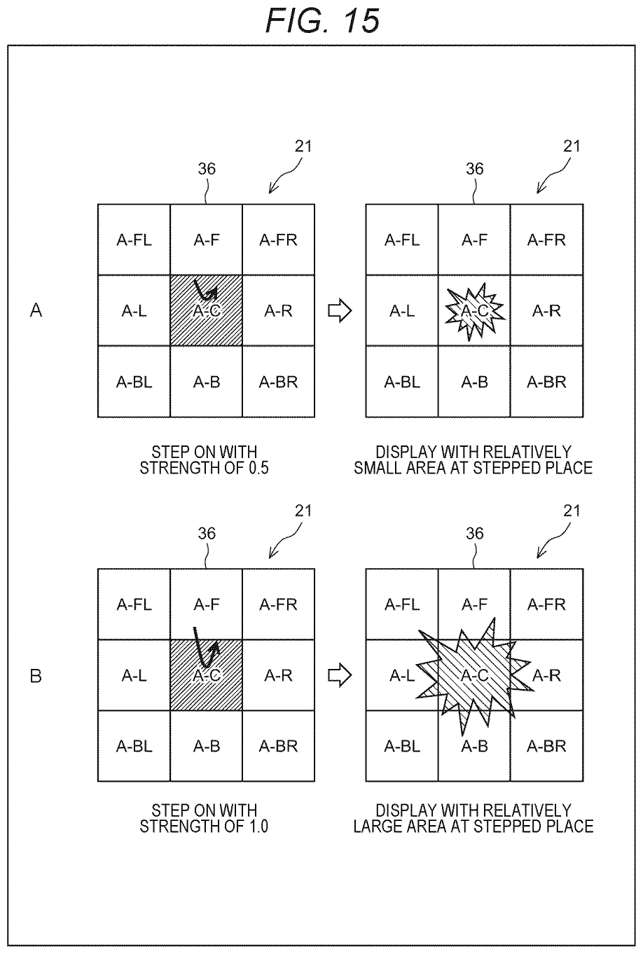

Video presentation processing is processing of presenting video information corresponding to the stepping position of the tactile presentation module 21 to the user, and is performed together with or instead of the vibration presentation. An embodiment of the vibration presentation processing will be described with reference to FIGS. 15 to 17. On the left side of each of A and B of FIG. 15, it is illustrated that the center position A-C of the tactile presentation module 21 (top plate 36) is stepped on. On the right side of each of A and B of FIG. 15, a video (also referred to as a stepping presentation image) presented at a center position A-C of the top plate 36 of the tactile presentation module 21 in a case where the center position A-C is stepped on is illustrated. For example, the video may be projected on the top plate 36 by a projector, or may be displayed by the top plate 36 having a display function. The presented stepping presentation image may be, for example, a figure, a symbol, an image and the like, and is not limited to a specific type.

A of FIG. 15 illustrates a case where the center position A-C of the top plate 36 is stepped on with a strength of 0.5. In contrast, B of FIG. 15 illustrates a case where the center position A-C of the top plate 36 is stepped on with a strength of 1. The stepping presentation image presented on the top plate 36 is changed depending on the strength of stepping. For example, as in A of FIG. 15, a stepping presentation image having a smaller area is presented as the strength of stepping is smaller, and as illustrated in B of FIG. 15, a stepping presentation image having a larger area is presented as the strength of stepping is larger. Therefore, the strength of the stepping is visually presented. Note that, a color, a shape, a pattern or the like of the stepping presentation image may be changed depending on the strength of the stepping. Furthermore, the stepping presentation image presented on the top plate 36 is changed around the stepping position. For example, when the stepping position is the left front position A-FL, the stepping presentation image is presented around the left front position A-FL (the central position of the region A-FL). Therefore, the stepping position is visually presented.

### Application Example 1

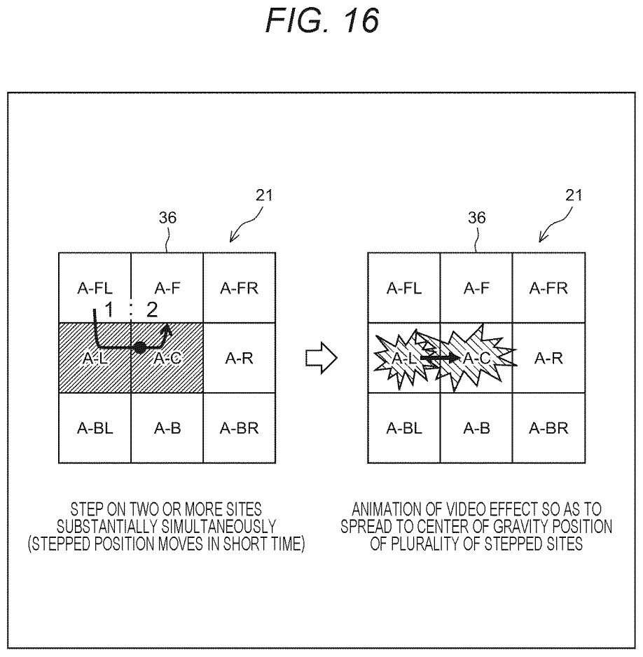

FIG. 16 is an explanatory diagram illustrating Application Example 1 of video presentation processing as in FIG. 15. On a left side of FIG. 16, it is illustrated that a top plate 36 of a tactile presentation module 21 is stepped on in the order of a left position A-L and a center position A-C. Furthermore, it is assumed that a stepping position is shifted from the left position A-L to the center position A-C in a short time (substantially simultaneously), and strengths of stepping are 1 and 2, respectively. Note that, when a ratio (change ratio of stepping strength) between a strength G1 of stepping at the stepping position (previous stepping position) first stepped and a strength G2 of stepping at the stepping position (subsequent stepping position) stepped later is represented by G1:G2, the change ratio of the strength of stepping is 1:2 in a case of FIG. 16. In this case, as illustrated in the diagram of the tactile presentation module 21 on a right side in FIG. 16, when the left position A-L, which is the previous stepping position, is stepped, a stepping presentation image having a size corresponding to a strength of stepping (1) is presented around the left position A-L. Subsequently, when the center position A-C, which is the subsequent stepping position, is stepped on, in a case where normal video presentation processing described with reference to FIG. 15 is performed, a stepping presentation image having a size corresponding to a strength of stepping (2) is presented around the center position A-C. In contrast, in this Application Example 1, a stepping presentation image having a size corresponding to the strength of stepping (2) is presented around a center of gravity position between the central position of the left position A-L, which is the previous stepping position, and the central position of the center position A-C, which is the subsequent stepping position. The center of gravity position represents a position obtained by dividing a line segment connecting the central position of the previous stepping position and the central position of the subsequent stepping position by a change ratio G1:G2 of the stepping strengths with the central position of the subsequent stepping position as a base point. Note that, instead of the change ratio G1:G2 of the stepping strength, the center of gravity position may be determined by using a ratio between a duration of the stepping at the previous stepping position and a duration of the stepping at the subsequent stepping position. Furthermore, when the stepping position shifts from the previous stepping position to the subsequent stepping position, the shift from the stepping presentation image presented around the previous stepping position to the stepping presentation image presented around the center of gravity position is performed with an animation of a continuous change, and an effect may be generated in which the stepping presentation image spreads around the center of gravity position.

### Application Example 2

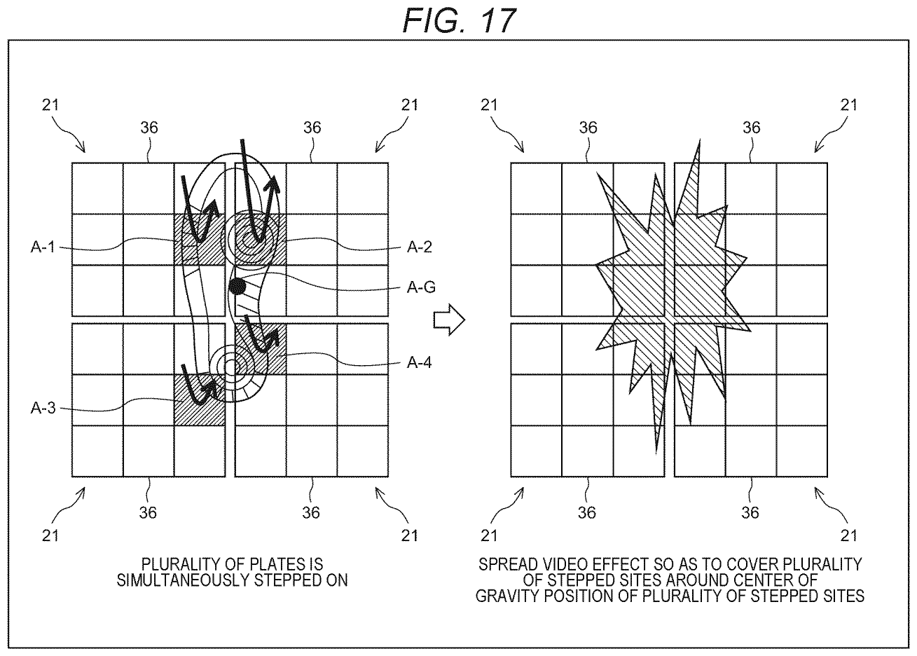

FIG. 17 is an explanatory diagram illustrating Application Example 2 of video presentation processing as in FIG. 15. On a left side of FIG. 17, top plates 36 of four (two by two) tactile presentation modules 21 adjacent to one another are illustrated, indicating that a position indicated by an image of a shoe sole is stepped on. Furthermore, it is assumed that regions A-1 to A-4 are detected as stepping positions in the four tactile presentation modules 21. The regions A-1 to A-4 are a right position A-R, a left position A-L, a right position A-R, and a left front position A-FL, respectively. In this case, when the normal video presentation processing described with reference to FIG. 15 is performed, individual stepping presentation images are presented around the respective regions A-1 to A-4. In contrast, in this Application Example 2, as illustrated in a right diagram of FIG. 17, one stepping presentation image around the center of gravity position of the regions A-1 to A-4 is presented in a size extending to the positions of the regions A-1 to A-4.

### <Timing of Vibration Presentation>

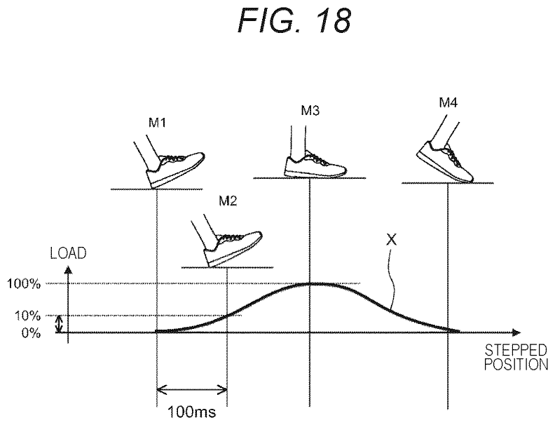

Vibration presentation is performed when the vibration actuator 39 starts vibrating at a timing when a predetermined condition is satisfied after stepping of the tactile presentation module 21 is detected. The timing of vibration presentation will be described with reference to FIG. 18. FIG. 18 illustrates a change in load when the user's foot changes as at steps M1 to M4 and the stepping position transitions by a graph line, with the position where the stepping is performed on the top plate 36 is plotted along the abscissa, and the load (pressure) applied to the top plate 36 is plotted along the ordinate. The load corresponds to the strength of stepping and a value (pressure value) of the detection signal detected by the pressure-sensitive sensor 37. According to this, when the stepping is started at step M1, an elapsed time from the start time point is measured. Furthermore, a maximum value of the load that is arrived in a case where the change occurs as at steps M1 to M4 is estimated on the basis of a time series change in the load (time series change in the pressure value) from the start time point. The maximum value of the load may be a case where the maximum value of the load is estimated on the basis of load information of the same user as the user who is performing the stepping of this time out of pieces of information of the load (load information) detected in the past by the tactile presentation module 21 itself and the other tactile presentation modules 21. The load information of the same user may be, for example, latest load information, load information similar to a time series change of a current load, or load information of a past stepping position of the same user specified using any information (image information and the like). Then, in a case where the elapsed time from the measured start time point reaches, for example, 100 ms, or in a case where the load detected by the pressure-sensitive sensor 37 reaches 10% of the maximum value, presentation of the vibration is started by the vibration actuator 39. At least, the vibration presentation is started in a case where the elapsed time from the start time point reaches, for example, 100 ms, because an allowable delay value (limit at which the delay of the vibration is not perceived) between the vibration presentation and an attitude-sensitive recognition such as swinging of a bat is generally 100 ms, and it is not necessarily limited to a case where 100 ms is the threshold. Furthermore, the vibration presentation is started in a case where the detected load reaches 10% of the maximum value of the estimated load, because it is necessary that a load of at least about 10% of the user's weight is applied to the tactile presentation module 21 in order for the vibration of the tactile presentation module 21 to be perceived by the user, and the vibration presentation is started in this state. Note that, the maximum value of the load is regarded as the weight of the user. However, the vibration presentation may be started when the detected load reaches a ratio other than 10% with respect to the maximum value of the estimated load.

### <Configuration Example of Tactile Presentation System>

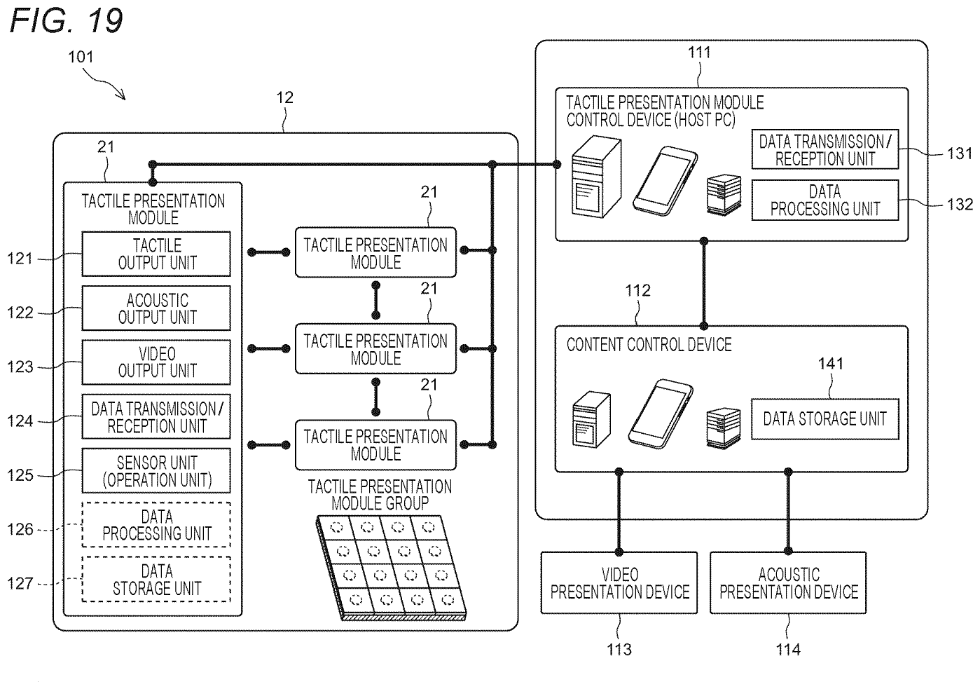

FIG. 19 is a configuration diagram illustrating a configuration example of a tactile presentation system 101. The tactile presentation system 101 in FIG. 19 is a system that controls the tactile presentation module group 12 including a large number of tactile presentation modules 21 of the tactile presentation plate 11 illustrated in FIGS. 1 to 3 and the like. Note that, the tactile presentation module 21 illustrated in FIG. 3 and the like is an example, and the tactile presentation module 21 described below is not limited to the configuration of FIG. 3. The tactile presentation system 101 includes the tactile presentation module group 12, a tactile presentation module control device 111, a content control device 112, a video presentation device 113, and an acoustic presentation device 114. The tactile presentation module group 12 is basically the same as the configuration described with reference to FIGS. 1 to 3 and the like, and thus detailed description thereof is omitted. The tactile presentation module group 12 includes the tactile presentation module 21, and is data-communicably connected between adjacent tactile presentation modules 21. The data communication between the tactile presentation modules 21 may be wired or wireless, and a communication scheme is not limited to a particular type. Furthermore, a case of being data-communicably connected among the tactile presentation modules 21 not adjacent to each other (especially, a case of the wireless data communication) is possible.

The particular tactile presentation module 21 or all of the tactile presentation modules 21 of the tactile presentation module group 12 are data-communicatively connected to the tactile presentation module control device 111 via a serial bus such as I2C. Even in a case where only a particular tactile presentation module 21 is data-communicably connected to the tactile presentation module control device 111, the other tactile presentation modules 21 can indirectly perform the data communication with the tactile presentation module control device 111 via data communication between the tactile presentation modules 21. The data communication between the tactile presentation module control device 111 and the tactile presentation module 21 may be wired or wireless, and a communication scheme is not limited to a particular type. Note that, a functional configuration of each tactile presentation module 21 will be described later. The tactile presentation module control device 111 is a device implemented by implementation of software including a program with a computer such as, for example, a personal computer (PC), a smartphone, the Raspberry Pi (registered trademark) as hardware. The tactile presentation module control device 111 includes a data transmission/reception unit 131 and a data processing unit 132. The data transmission/reception unit 131 controls data communication with the tactile presentation module 21 of the tactile presentation module group 12 and data communication with the content control device 112. The data processing unit 132 executes the above-described stepping detection processing, inclination detection processing, vibration presentation processing, video presentation processing and the like, and controls the tactile presentation module 21 (mainly the vibration actuator 39) and the content control device 112 on the basis of a processing result.

The content control device 112 functions as a device that mainly provides tactile data, acoustic data, and video data by using, for example, the PC, smartphone, server and the like as hardware. The content control device 112 may be a device integrated with the tactile presentation module control device 111. The content control device 112 includes a data storage unit 141. The data storage unit 141 includes, for example, the tactile data, acoustic data, and video data as content data generated in advance. The tactile data is data for causing the tactile presentation module 21 to generate and present tactile information such as vibration, temperature, and force sense in various forms in response to user's stepping in the tactile presentation module group 12. The acoustic data is data for causing the acoustic presentation device 114 to generate and present acoustic in various forms in response to user's stepping in the tactile presentation module group 12. The video data is data for causing the video presentation device 113 to display and present videos in various forms in response to the user's stepping in the tactile presentation module group 12.

The video presentation device 113 is any display device such as a monitor, a video projection device (projector), and a head mounted display (HMD). The video presentation device 113 displays the video data supplied from the content control device 112. For example, a projector that projects video on the tactile presentation module group 12 is used as the video presentation device 113, and the video in the video presentation processing described with reference to FIGS. 15 to 17 is projected to be displayed on the tactile presentation module 21 on the basis of the video data. The acoustic presentation device 114 is any acoustic output device such as a speaker and a headphone. The acoustic presentation device 114 outputs the acoustic data supplied from the content control device 112. For example, when the user walks on the tactile presentation module group 12, footsteps corresponding to the assumed environment are output from the acoustic presentation device 114.

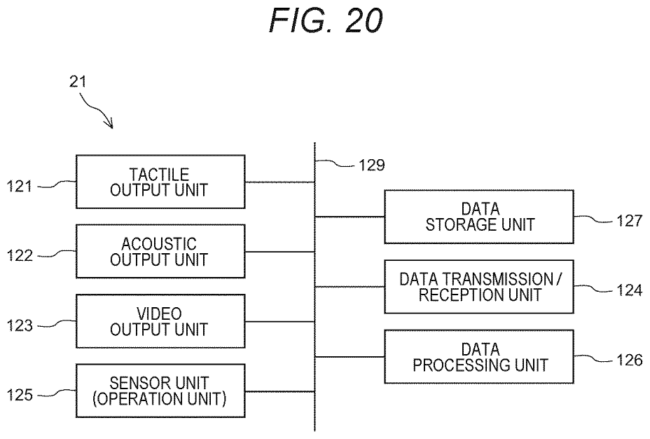

FIG. 20 is a functional block diagram illustrating a functional configuration of the tactile presentation module 21. This is common to the functional block illustrated in the block of one tactile presentation module 21 in FIG. 19, so that the functional configuration of the tactile presentation module 21 will be described with reference to FIG. 20. In FIG. 20, the tactile presentation module 21 includes a tactile output unit 121, an acoustic output unit 122, a video output unit 123, a data transmission/reception unit 124, a sensor unit 125, a data processing unit 126, a data storage unit 127, and a data transmission path 128. The tactile output unit 121, the acoustic output unit 122, the video output unit 123, the data transmission/reception unit 124, the sensor unit 125, the data processing unit 126, and the data storage unit 127 mutually transmit and receive data via the data transmission path 128. The tactile output unit 121 presents the tactile information. For example, the tactile output unit 121 includes the above-described vibration actuator 39. Furthermore, the tactile output unit 121 includes one that presents the tactile information not only by vibration but also by temperature, force sense and the like. The acoustic output unit 122 presents acoustic information. For example, the acoustic output unit 122 includes a speaker and the above-described vibration actuator 39. The video output unit 123 presents the video information. For example, the video output unit 123 includes a display mounted on the upper surface of the top plate 36 described above. A device that presents the video information to the top plate 36 may be an external video projection device (such as a projector), and the video projection device in this case is included in a video presentation device 119 in FIG. 19. The data transmission/reception unit 124 controls data communication with the outside. For example, the data transmission/reception unit 124 controls data communication with the tactile presentation module control device 111 and the data communication with other tactile presentation modules 21.

The data transmission/reception unit 124 transmits and receives, for example, a control command, data at the time of initial setting, or control data itself to and from the tactile presentation module control device 111 directly or indirectly via another tactile presentation module 21 by data communication. The sensor unit 125 acquires information regarding interaction of a person (strength of stepping of foot, operation condition of operation unit and the like). The sensor unit 125 includes the pressure-sensitive sensor 37 and the gyro sensor 40 described above. The data processing unit 126 generates a control command itself, reads a control signal from the data storage unit 127 on the basis of the received command, and performs optimization (adjust output intensity, modulate frequency and the like) on the basis of the sensor information from the sensor unit 125. The processing executed by the data processing unit 126 may include the above-described stepping detection processing, inclination detection processing, vibration presentation processing, video presentation processing and the like. The data storage unit 127 acquires and stores in advance the acoustic data, video data, tactile data and the like stored in the data storage unit 141 and the like of the content control device 112 from the tactile presentation module control device 111. Note that, the data processing unit 126 and the data storage unit 127 are not necessarily included in the tactile presentation module 21, and may be included in the tactile presentation module control device 111 and the content control device 112. Furthermore, the acoustic output unit 122 and the video output unit 123 are not necessarily included in the tactile presentation module 21.

### <Processing Procedure of Tactile Presentation System>

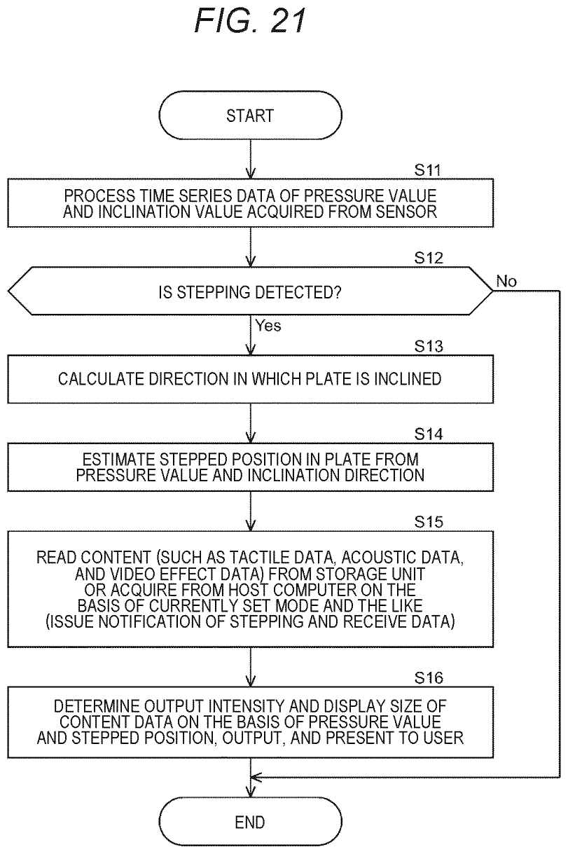

FIG. 21 is a flowchart illustrating a processing procedure of the tactile presentation system 101. The processing in this flowchart is mainly performed by the data processing unit 126 of the tactile presentation module 21 in FIG. 20, but may be performed by the data processing unit 132 of the tactile presentation module control device 111 in FIG. 19. At step S11, the data processing unit 126 processes the time series data of the pressure value (detection data of the pressure-sensitive sensor 37) and an inclination value (detection signal of the gyro sensor 40) acquired from the sensor unit 125. At step S12, the data processing unit 126 determines whether or not stepping on the tactile presentation module 21 (top plate 36) is detected on the basis of the data acquired at step S11. In a case of negative determination at step S12, the processing of this flowchart is ended. In a case of affirmative determination at step S12, the processing proceeds to step S13.

At step S13, the data processing unit 126 calculates an inclination direction of the top plate 36 on the basis of the data acquired at step S11. At step S14, the data processing unit 126 estimates (specifies) the stepping position in the top plate 36 on the basis of the pressure value acquired at step S11 and the inclination direction calculated at step S13. At step S15, the data processing unit 126 reads the content data (tactile data, acoustic data, video data and the like) from the data storage unit 127 on the basis of a currently set mode (a mode corresponding to the assumed environment and the like). Note that, it is possible to notify the tactile presentation module control device 111 of the detection of the stepping, and the content data may be acquired from the data storage unit 141 of the content control device 112 by data communication via the tactile presentation module control device 111. At step S16, the data processing unit 126 determines the output intensity and the display size of the content data on the basis of the pressure value and the stepping position, causes the tactile output unit 121, the acoustic output unit 122, the video output unit 123 and the like to output the content data, and presents the content data to the user. When the processing at step S16 is ended, the processing of this flowchart is ended.

Note that, a plurality of the present technologies that has been described in the present specification can be implemented independently as a single unit unless there is a contradiction. It goes without saying that any plurality of present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

### <Combination Example of Configurations>

Note that, the present technology can also have the following configurations.

(1)

An information processing device including:
a processing unit configured to detect a position to which a pressure is applied out of a plurality of positions of a plate-shaped body on the basis of a first signal indicating a pressure applied to the plate-shaped body and a second signal indicating an inclination direction of the plate-shaped body.
   (2)

The information processing device according to (1) described above, in which
the processing unit updates a threshold for determining whether or not the pressure is applied to the plate-shaped body on the basis of the first signal.
   (3)

The information processing device according to (2) described above, in which
the processing unit sets, as the threshold, a smallest value out of values of a plurality of signals after the first signal is subjected to filter processing by a plurality of filters having different characteristics.
   (4)

The information processing device according to (3) described above, in which
the plurality of filters is a plurality of low-pass filters having different cutoff frequencies.
   (5)

The information processing device according to any one of (1) to (4) described above, in which
the processing unit performs offset removal processing on the second signal.
   (6)

The information processing device according to (5) described above, in which
the offset removal processing is processing of gradually or stepwise bringing the second signal closer to 0 with a lapse of time.
   (7)

The information processing device according to any one of (1) to (6) described above, in which
the second signal is an angle signal.
   (8)

The information processing device according to any one of (1) to (7) described above, in which
the second signal is an angular velocity signal.
   (9)

The information processing device according to any one of (1) to (8) described above, in which
the processing unit detects a region to which a pressure is applied out of regions obtained by dividing the plate-shaped body into nine sections as the position to which the pressure is applied.
   (10)

The information processing device according to any one of (1) to (9), in which
the processing unit controls presentation of tactile information on the basis of a detected result.
   (11)

The information processing device according to (10) described above, in which
the processing unit changes a form of the tactile information to be presented depending on the detected position.
   (12)

The information processing device according to any one of (1) to (11), in which
the processing unit controls presentation of video information on the basis of a detected result.
   (13)

The information processing device according to (12) described above, in which
the processing unit changes a presentation position of the video information depending on the detected position.
   (14)

The information processing device according to (12) or (13) described above, in which
the processing unit changes a size of presentation of the video information depending on the pressure applied to the plate-shaped body.
   (15)

The information processing device according to any one of (12) to (14) described above, in which
the processing unit sets a center of gravity position between the detected position and a position to which a pressure is applied to another plate-shaped body adjacent to the plate-shaped body as a presentation position of the video information.
   (16)

An information processing method of an information processing device including
a processing unit, the information processing method including:
detecting a position to which a pressure is applied out of a plurality of positions of a plate-shaped body on the basis of a first signal indicating a pressure applied to the plate-shaped body and a second signal indicating an inclination direction of the plate-shaped body by the processing unit.
   (17)

An information processing device including:
a plate-shaped body;
a first sensor configured to output a first signal indicating a pressure applied to the plate-shaped body; and
a second sensor configured to output a second signal indicating an inclination direction of the plate-shaped body.
   (18)

The information processing device according to (17) described above, including:
a first member configured to support the plate-shaped body; and
a second member interposed between the first sensor and the plate-shaped body, in which
the first member has a Young's modulus larger than a Young's modulus of the second member.
   (19)

The information processing device according to (17) or (18) described above, in which
the second sensor is fixed to the plate-shaped body.
   (20)

The information processing device according to any one of (17) to (19) described above, including:
an actuator configured to vibrate the plate-shaped body, in which
the actuator is arranged between the plate-shaped body and the first sensor.

### REFERENCE SIGNS LIST

11 Tactile presentation plate
12 Tactile presentation module group
13 Plate-shaped body
21 Tactile presentation module
31 Bottom plate
32 Frame
34 Gel portion
36 Top plate
37 Pressure-sensitive sensor
38 Sponge portion
39 Vibration actuator
40 Gyro sensor
101 Tactile presentation system

What is claimed is:

1. An information processing device, comprising:
a processing unit configured to detect a position to which a pressure is applied out of a plurality of positions of a plate-shaped body on a basis of a first signal indicating a pressure applied to the plate-shaped body and a second signal indicating an inclination direction of the plate-shaped body.

2. The information processing device according to claim 1, wherein
the processing unit updates a threshold for determining whether or not the pressure is applied to the plate-shaped body on a basis of the first signal.

3. The information processing device according to claim 2, wherein
the processing unit sets, as the threshold, a smallest value out of values of a plurality of signals after the first signal is subjected to filter processing by a plurality of filters having different characteristics.

4. The information processing device according to claim 3, wherein
the plurality of filters is a plurality of low-pass filters having different cutoff frequencies.

5. The information processing device according to claim 1, wherein
the processing unit performs offset removal processing on the second signal.

6. The information processing device according to claim 5, wherein
the offset removal processing is processing of gradually or stepwise bringing the second signal closer to 0 with a lapse of time.

7. The information processing device according to claim 1, wherein
the second signal is an angle signal.

8. The information processing device according to claim 1, wherein
the second signal is an angular velocity signal.

9. The information processing device according to claim 1, wherein
the processing unit detects a region to which a pressure is applied out of regions obtained by dividing the plate-shaped body into nine sections as the position to which the pressure is applied.

10. The information processing device according to claim 1, wherein
the processing unit controls presentation of tactile information on a basis of a detected result.

11. The information processing device according to claim 10, wherein
the processing unit changes a form of the tactile information to be presented depending on the detected position.

12. The information processing device according to claim 1, wherein
the processing unit controls presentation of video information on a basis of a detected result.

13. The information processing device according to claim 12, wherein
the processing unit changes a presentation position of the video information depending on the detected position.

14. The information processing device according to claim 12, wherein
the processing unit changes a size of presentation of the video information depending on the pressure applied to the plate-shaped body.

15. The information processing device according to claim 12, wherein
the processing unit sets a center of gravity position between the detected position and a position to which a pressure is applied to another plate-shaped body adjacent to the plate-shaped body as a presentation position of the video information.

16. An information processing method of an information processing device, including
a processing unit, the information processing method comprising:
detecting a position to which a pressure is applied out of a plurality of positions of a plate-shaped body on a basis of a first signal indicating a pressure applied to the plate-shaped body and a second signal indicating an inclination direction of the plate-shaped body by the processing unit.

17. An information processing device, comprising:
a plate-shaped body;
a first sensor configured to output a first signal indicating a pressure applied to the plate-shaped body; and
a second sensor configured to output a second signal indicating an inclination direction of the plate-shaped body.

18. The information processing device according to claim 17, comprising:
a first member configured to support the plate-shaped body; and
a second member interposed between the first sensor and the plate-shaped body, wherein
the first member has a Young's modulus larger than a Young's modulus of the second member.

19. The information processing device according to claim 17, wherein
the second sensor is fixed to the plate-shaped body.

20. The information processing device according to claim 17, comprising:
an actuator configured to vibrate the plate-shaped body, wherein
the actuator is arranged between the plate-shaped body and the first sensor.
